(19) United States
(12) Patent Application Publication
(10) Pub. No.: US 2016/0283903 A1
(43) Pub. Date: Sep. 29, 2016

(54) System and Method for Allowing Delivery Vehicle to Deliver In Resident Lanes With Windshield Mounted RFID Transponder or Optical Character Recognition

(71) Applicant: Gonzalo Fernandez, Miramar, FL (US)

(72) Inventor: Gonzalo Fernandez, Miramar, FL (US)

(21) Appl. No.: 14/667,067

(22) Filed: Mar. 24, 2015

(51) Int. Cl. G06Q 10/08; G06K 7/10

(52) U.S. Cl. CPC G06Q 10/0835; G06K 7/10366

(57) ABSTRACT

A delivery method and system allows a delivery vehicle to deliver in resident lanes. A delivery provider selects a delivery vehicle to perform the delivery. The delivery vehicle has a mounted transponder that emits a unique identifying signal to a reader at the resident lane. The reader may also be operable to capture an image of the license plate of the vehicle for identification. The delivery provider relays the identifying signal of the delivery vehicle to a data storage. During delivery, the vehicle engages a resident lane in the community. The reader at the resident lane identifies the identifying signal emitting from the transponder or the captured image. The reader communicates with the transponder. Depending on the identifying signal emitted from the transponder, the reader can grant the vehicle access for one-time entry through the resident lane unique. The one time entry can be resubmitted for subsequent deliveries.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to a delivery method and system that allows a delivery vehicle carrying a delivery order to pass through a resident lane in a private community, rather than a guest lane. The method and system may utilize transponders or optical character recognition of a license plate to recognize the delivery vehicle, and then enable the delivery vehicle to pass through.

The inventor recognized a problem in receiving service deliveries at a private, gated community. There were often undue delays as the delivery vehicle had to wait in a guest lane until approved by a guard. The guard would call the service recipient to verify that the service was, indeed, authorized. The inventor recognized that this slowed down the service and created excessive delay.

This was because the private community is a form of residential community or housing estate containing strictly controlled entrances for pedestrians, bicycles, and automobiles; and often characterized by a closed perimeter of walls. A guard house, either manned or automated, regulates access to the private community through an entrance gate.

The inventor observed that the resident lane at the access gate allowed for expedited entry into the private community. However, the guest lane for nonresidents often took longer duration to enter through, and required permission and identification, usually processed at the access gate. The inventor realized that a delivery method would need to circumvent the guest lane by automating access through the resident lane to a delivery driver, who may not visit the private community regularly.

The inventor knew that delivery of products and services often occurs to a private community. Through experience, the inventor was aware that upon arriving at the outer perimeter of the gate, the delivery vehicle must pass numerous security and identification checks at the entrance gate. The delivery requester who ordered the delivery order may also have to be contacted to verify that the delivery was requested. Consequently, the delivery can be belated—sometimes significantly. This may especially be detrimental for hot food deliveries, such as pizza and Chinese food.

Another common problem observed by the inventor was that security was not maintained when a variety of delivery orders pass through the private community. A criminal may pose as a delivery driver, yet may only be performing reconnaissance on the homes and residents in the private community for future criminal activity. Presently, there is not a systematic way for both the private community, the delivery provider, and the delivery requester to document each delivery and maintain the exact same information.

Additional problems noticed by the inventor were that irregular deliveries to a private community include a backlog of vehicles at the guest lane, differentiating between private and commercial vehicles, and paying security personnel to regulate the various vehicles coming and going through the private community.

The inventor was aware that a vehicle could be identified with various technologies. Through research, the inventor learned that a windshield mounted transponder could communicate with a transmitting reader that was positioned near a resident lane of the community.

The inventor experimented by placing a reader at the entrance to the resident lane proximally to the vehicle. The reader could then communicate with the windshield mounted transponder to verify an identifying signal emitting from the transponder. The reader could then trigger an entry for the delivery vehicle if the vehicle was positively identified.

The inventor knew that this would allow the reader would allow a one-time entry for a vehicle for each delivery order based on verification of the identifying signal. The delivery vehicle could be made to utilize an active RFID windshield mounted transponder, or a sticker RFID passive transponder.

Through additional research, the inventor learned that the reader could also use optical character recognition technology to capture an image of the license plate or other identifier, such as a bar code, on the vehicle. In this manner, the license plate could be verified to enable faster entry of the delivery vehicle. The reader could further use infrared lighting so as to capture the image at night or in bad weather.

For the foregoing reasons, there is a delivery system and method that expedites the delivery order, records all aspects of the delivery order, enhances security for the private community, and informs a private community, delivery requester, and a delivery provider about the status of the delivery.

Delivery systems and methods have been utilized in the past; yet none with the present delivery expediting characteristics of the present invention. See U.S. Patent No. 20020032613; U.S. Pat. No. 7,973,642; and 20130049932.

For the foregoing reasons, there is a delivery method and device that allows a delivery vehicle to pass through a resident lane in a private community and avoid a guest lane through the use of an identifying signal emitted from a transponder or through optical character recognition technology of a license plate.

### SUMMARY

The present invention describes a system and method that facilitates access to a private community having regulated access through a resident lane, rather than a guest lane. A reader at the resident lane identifies the delivery vehicle through a transponder or through optical character recognition technology to authorize passage of the delivery vehicle through the resident lane. In this manner, the delivery vehicle is not delayed waiting at the guest lane.

In one embodiment, the delivery method and system provides the delivery vehicle with a windshield mounted transponder, or may also capture an image of the license plate through optical character recognition. A reader positioned proximally to the resident lane communicates with the transponder to verify an identifying signal emitting from the transponder. The reader can allow a one-time entry of the vehicle for each delivery order based on verification of the identifying signal. The delivery vehicle may utilize an active RFID windshield mounted transponder, or a sticker RFID passive transponder.

In another embodiment, the reader utilizes optical character recognition to capture an image of the license plate or other identifier on the vehicle, such as a bar code. The reader may utilize infrared lighting so as to capture the image at night or in bad weather.

In some embodiments, the delivery method and system for allowing a delivery vehicle to deliver in resident lanes may initiate with a delivery order transaction from a delivery requester and a delivery provider processing the order. The delivery provider selects a delivery vehicle to perform the delivery.

The delivery vehicle includes a transponder that emits a unique identifying signal. The delivery provider relays the identifying signal of the delivery vehicle to a data storage. However, in other embodiments, optical character recognition technology may be used to identify a license plate or other identifier on the delivery vehicle.

During delivery to the delivery requester, the delivery vehicle engages a resident lane in the private community. The resident lane comprises a reader for reading an identifying signal emitting from the delivery vehicle. The reader communicates with the transponder on the delivery vehicle. Depending on the identifying signal emitted from the transponder, the reader can grant the delivery vehicle access for a one-time entry through the resident lane unique. The one-time entry can be resubmitted for subsequent deliveries.

One objective of the present invention is to expedite delivery times by enabling the delivery vehicle to access the resident lane, rather than the guest lane.

Another objective of the present invention is to maintain a record of the delivery for delivery status updates, book keeping and marketing.

Another objective of the present invention is to communicate with the delivery vehicle through an active RFID windshield mounted transponder, a sticker RFID passive transponder, or optical character recognition that captures an image of the license plate or other identifier on the vehicle.

Yet another objective of the present invention is to reduce fuel costs for the delivery vehicle.

Yet another objective is to reduce backlogs of vehicles at the guest lane by enabling the delivery vehicles to bypass the guest lane completely.

One advantage of the present invention is that the delivery requester receives the delivery order faster.

Another advantage of the present invention is that the private community, the delivery requester, and the delivery provider can be informed about the status of the delivery from the point that the delivery vehicle arrives at the resident lane.

Yet another advantage of the present invention is that the transponder is a relatively inexpensive and common radio frequency identification tag.

Yet another objective is to provide an inexpensive to manufacture reader and transponder for identifying the delivery vehicle to enable passage through the resident lane.

### DRAWINGS

These and other features, aspects, and advantages of the present invention will become better understood with regard to the following description, appended claims, and drawings where:

FIG. 1 is a flowchart showing the steps in an exemplary delivery method;

FIG. 2 is a block diagram showing the chief components of an exemplary delivery system; and

FIG. 3 is a block diagram depicting an exemplary client/server system which may be used by an exemplary web-enabled/networked embodiment of the present invention.

### DESCRIPTION

The present invention is directed to a method 100 and system 200 for enabling a delivery to a private community 206 that has regulated access by enabling a delivery vehicle 210 to pass through a resident lane 214, rather than a guest lane 218. Accessing the community 206 through the resident lane 214, rather than the guest lane 218, expedites the delivery and provides numerous advantages for transacting the delivery order. A variety of communication technologies, radio frequencies, and processors may be utilized to identify the delivery vehicle 210 for one time passage through the resident lane 214.

In one embodiment, the delivery method 100 and system 200 provides the delivery vehicle 210 with a transponder 212 that mounts on the windshield of the delivery vehicle 210. A reader 216 positions proximally to the resident lane 214 and communicates with the transponder 212 to verify an identifying signal emitting from the transponder 212.

The reader 216 may then allow a one-time entry of the delivery vehicle 210 for each delivery order based on verification of the identifying signal. In one embodiment, the delivery vehicle 210 may utilize an active RFID windshield mounted transponder, or a sticker RFID passive transponder to communicate with the reader 216. In another embodiment, the reader 216 utilizes optical character recognition to capture an image of the license plate or other identifier, such as a bar code, on the delivery vehicle 210. The reader 216 may utilize infrared lighting so as to capture the image at night or in bad weather.

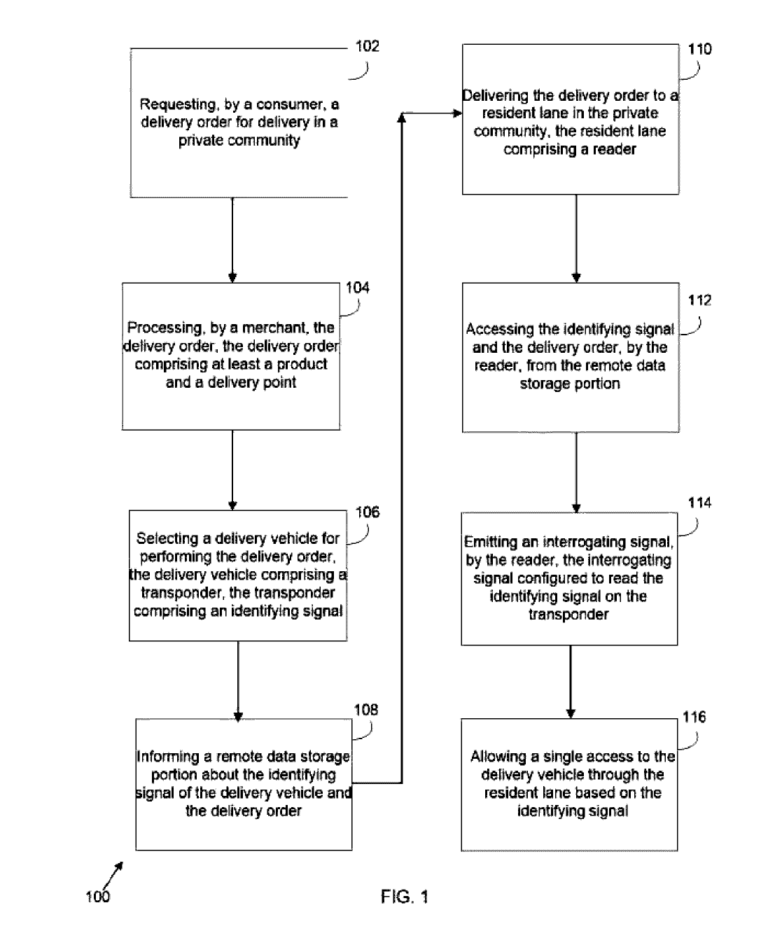

FIGS. 1 to 3 depict the delivery method 100 and system 200. In one embodiment of the present invention, the method 100 and system 200 initiate with a delivery order request from a delivery requester 202 at a private community 206. A delivery provider 208 receives and processes the delivery order. The delivery provider 208 may include, without limitation, a restaurant, a flower shop, a package delivery, a post office, a cleaning service, and a service provider.

The delivery provider 208 also selects a delivery vehicle 210 to perform the delivery. The delivery vehicle 210 may include, without limitation, a car, a truck, a van, a motorcycle, and a bicycle. The delivery vehicle 210 utilizes a transponder 212 that emits a unique identifying signal 222. The delivery provider 208 relays the identifying signal 222 of the delivery vehicle 210 to a data storage portion 220 for storage and processing.

During delivery to the delivery requester 202, the delivery vehicle 210 engages a resident lane 214 in the private community 206. The resident lane 214 comprises a reader 216 for reading an identifying signal 222 emitting from the delivery vehicle 210. The reader 216 communicates with the data storage portion 220 to request and receive the identifying signal 222 for the expected delivery.

The reader 216 may include, without limitation, a radio frequency transmitter, a camera, and a satellite. In one embodiment, the reader 216 utilizes radio-frequency identification, where an antenna proximal to the resident lane 214 toll gate communicates with a transponder on the vehicle via Dedicated Short Range Communications (DSRC). However, any number of identifying technologies may be used.

The reader 216 also communicates with the transponder 212 on the delivery vehicle 210. Depending on the identifying signal 222 emitted from the transponder 212, the reader 216 may grant the delivery vehicle 210 access for a one-time entry through the resident lane 214. The one-time entry through the resident lane 214 can be resubmitted for each subsequently requested delivery order.

All aspects of the delivery, including: information about access to the resident lane 214, the product being delivered, a delivery address, a time of delivery, and the like may be recorded in a remote data storage portion 220 and relayed to the private community 206, and/or the delivery provider 208 and/or the delivery requester 202.

In this manner, numerous advantages are found, including: expediting of the delivery order, recording of all aspects of the delivery order, enhancing security for the private community 206, and informing a delivery requester 202 and a delivery provider 208 about the status of the delivery order.

FIG. 1 illustrates a flowchart diagram for a delivery method 100 that facilitates access to a private community 206 for a delivery vehicle 210 by enabling access through a resident lane 214, rather than a guest lane 218. The method 100 may include an initial Step 102 of requesting, by a delivery requester 202, a delivery order to be delivered in a private community 206. The delivery requester 202 may place the delivery order by telephone, text, internet, or fax.

In some embodiments, the order may include a product and a delivery point 204, such as an address. The delivery point 204 may include a residence in a private community 206. However in other embodiments, any delivery point 204 within a community having access restrictions may utilize the delivery method. The product for delivery may include, without limitation, a food order, a home accessory order, and a service order.

Those skilled in the art will recognize that a private community 206 is a form of residential community or housing estate containing strictly controlled entrances for pedestrians, bicycles, and automobiles; and often characterized by a closed perimeter of walls. A guard house, either manned or automated, regulates access to the private community 206 through an entrance gate.

In some embodiments, a resident lane 214 at the access gate allows for expedited entry into the private community 206. A guest lane 218 for nonresidents often takes a longer duration to enter through, and requires permission and identification, usually processed at the access gate. The delivery method attempts to circumvent the guest lane 218 by automating access through the resident lane 214 to a delivery driver, who may not visit the private community 206 regularly.

In some embodiments, a Step 104 may include processing, by a delivery provider 208, the delivery order. The delivery provider 208 receives the delivery order and prepares the product for delivery. The delivery provider 208 may also process the cost and estimated time of arrival, relaying this information to the delivery requester 202.

The method 100 further includes a Step 106 comprising selecting a delivery vehicle 210 for performing the delivery order. The delivery vehicle 210 may include an automobile sized and dimensioned for carrying the product. For example, the delivery vehicle 210 may include a pizza delivery car.

Additionally, the delivery vehicle 210 utilizes a transponder 212 that emits a unique identifying signal 222. The identifying signal 222 is associated solely with the delivery vehicle 210. The transponder 212 communicates through radio frequencies to signal the identifying signal 222 to receivers, frequency readers, positioning systems, and other communication devices.

However in other embodiments, the delivery vehicle 210 may utilize any number of radio frequency identifying devices known in the art, including devices that utilize wireless non-contact use of radio-frequency electromagnetic fields to transfer data for the purposes of automatically identifying and tracking tags attached to objects. In one alternative embodiment, the delivery vehicle 210 may be identified through a smart phone that uses near field communication (NFC), whereby the identifying signal 222 stores on a smart phone in the delivery vehicle 210 and transmits the identifying information to a correlating smart phone at the access gate for the resident lane 214.

A Step 108 comprises informing a remote data storage portion 220 about the identifying signal 222 of the delivery vehicle 210 and the delivery order. The delivery provider 208 relays specifics of the delivery order, such as the delivery point 204, the product, the price, and special requests to the remote data storage portion 220. The delivery provider 208 may also relay the identifying signal 222 of the delivery vehicle 210 to the data storage portion 220. The private community 206 and/or the delivery provider 208 and/or the delivery requester 202 can receive information pertinent to the delivery order from the remote data storage portion 220.

The remote data storage portion 220 may include, without limitation, a central processing unit, a cloud, a server, a multi-tier server, a network, and a log book. The delivery provider 208 and/or the delivery requester 202 can have access to the remote data storage portion 220 from different platforms.

In some embodiments, a Step 110 comprises delivering the delivery order to a resident lane 214 in the private community 206. The resident lane 214 provides the most efficient route to the delivery point 204, which is the final destination for the delivery. The delivery vehicle 210 in the present invention attempts to utilize the resident lane 214 to avoid the limitations and obstacles imposed by the guest lane 218. In one embodiment, the resident lane 214 includes a reader 216. The transponder 212 on the delivery vehicle 210 positions on the front windshield of the delivery vehicle 210, oriented towards the reader 216 while transmitting the identifying signal 222.

In one embodiment, an active RFID windshield mounted transponder, a sticker RFID passive transponder. In another embodiment, the reader 216 uses optical character recognition to capture an image of the license plate or other identifier on the delivery vehicle 210. In either case, the delivery vehicle 210 is identified for authorized entry through the resident lane 214.

The method 100 also utilizes a Step 112 of accessing the identifying signal 222 and the delivery order, by the reader 216, from the remote data storage portion 220. The reader 216 forms an electronic communication device configured to communicate simultaneously with the remote data storage portion 220 and the transponder 212. The reader 216 positions proximally to the resident lane 214, such as at an access gate.

In some embodiments, the reader 216 may utilize various signal to communicate with the remote data storage portion 220, including, without limitation, radio, electrical, or optical connectivity. The reader 216 can also receive information about the delivery order from the remote data storage portion 220.

A Step 114 may include emitting an interrogating signal 224, by the reader 216, the interrogating signal 224 configured to read the identifying signal 222 on the transponder 212. The interrogating signal 224 may include a radio frequency. The interrogating signal 224 serves to search for an identifying signal 222 from the transponder 212 that matches the identifying signal 222 in the remote data storage portion 220.

In some embodiments, the reader 216 has sufficient processing capacity to correlate the identifying signal 222 with the delivery order information from the remote data storage portion 220, including, the delivery point 204, the expected product to be delivered, and the estimated time of arrival. In this manner, the reader 216 may utilize circuitry logic known in the art to make decisions and relay selected information as required.

A final Step 116 comprises allowing a single access to the delivery vehicle 210 through the resident lane 214 based on the identifying signal 222. Upon receiving a matching identifying signal 222 from the transponder 212, the reader 216 enables access to the private community 206. For example, the reader 216 transmits an actuation signal to a solenoid to open a gate for the resident lane 214.

It is significant to note that the reader 216 only permits one entry for the identifying signal 222. However for subsequent delivery orders, the remote data storage portion 220 can resubmit the identifying signal 222 such that the same delivery vehicle 210 can make multiple deliveries to the same private community 206.

In some embodiments, the reader 216 reconnects with the remote data storage portion 220 to inform that access to the resident lane 214 has be enabled for the identifying signal 222 in question. The remote data storage portion 220 may then relay this information to the private community 206, the delivery provider 208 and/or the delivery requester 202.

In one embodiment, the private community 206 receives and processes the information regarding the delivery order and the status of the delivery vehicle 210 from the remote data storage portion 220. The private community 206 may then compile the information to form a delivery record. The delivery record enables the private community 206 better understand the comings and goings inside the private community 206.

For example, the private community 206 is made aware of when and how often the different delivery vehicles 210 enter the private community 206. Also, the length of time that the delivery vehicle 210 stays in the private community 206 is recorded. This information enhances security because the private community 206 then knows how many and where security personnel should be positioned.

Also, any security cameras can be trained on specific areas of the private community 206. In one further example of how the private community 206 gathers and uses the delivery order information, the resident lane 214 utilizes an image capturing device (not shown) in conjunction with the reader 216. The image capturing device may include a security camera that is configured to capture an image of the delivery vehicle 210 upon entry through the resident lane 214. In this manner, security in the private community 206 is enhanced, as an image of the vehicle license plate and the vehicle operator are recorded.

In yet another embodiment, the private community 206 can use the information about the delivery order for marketing purposes, matching the different delivery requesters 202 with potential products and services. For example, the delivery requester 202 who requests numerous deliveries is put on a list to receive coupons.

In another alternative embodiment, a plurality of readers may be positioned throughout a region to monitor the location of the delivery vehicle 210. In yet another alternative embodiment, the system 200 may utilize a global positioning system to monitor the location of the delivery vehicle 210 and enable access to the resident lane 214.

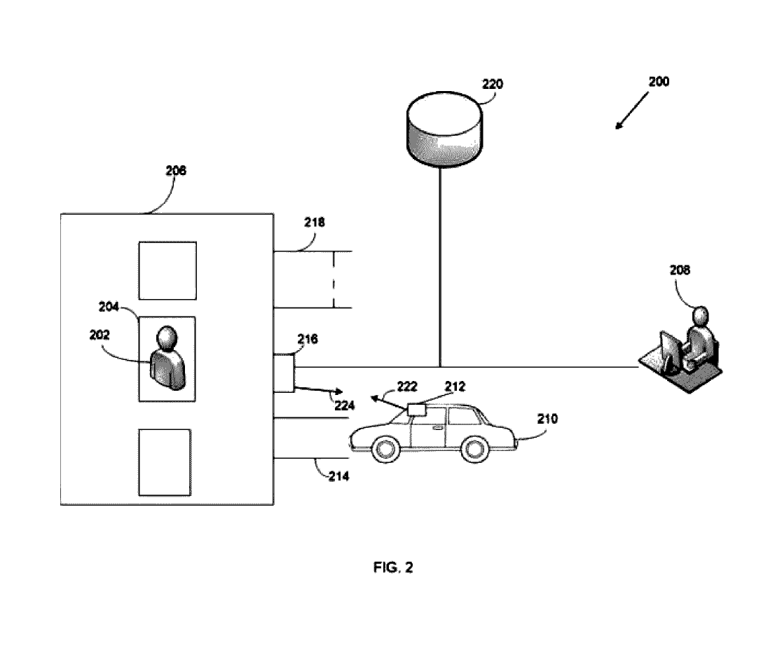

Turning now to FIG. 2, a delivery system 200 enables a delivery vehicle 210 to deliver in a resident lane 214 of a private community 206; thereby avoiding a guest lane 218. The system 200 initiates with a delivery requester 202 requesting a delivery order from a private community 206. In one example, the delivery requester 202 may order pizza to a gated residential community. However, any community having restricted access and expedited access lanes may use the system 200.

In some embodiments, the delivery requester 202 orders the delivery order from a delivery provider 208. The delivery provider 208 can then process the delivery order, and decipher any delivery order information, such as the product and the delivery point 204. The delivery provider 208 selects a delivery vehicle 210 to deliver the delivery order. The delivery vehicle 210 may carry a transponder 212, or radio frequency identification tag known in the art. The transponder 212 emits a unique identifying signal 222 for the delivery vehicle 210.

A remote data storage portion 220 is configured to store and process the delivery order and the identifying signal 222 of the delivery vehicle 210. The remote data storage portion 220 may include, without limitation, a central processing unit, a cloud, a server, a multi-tier server, a network, and a log book.

In one embodiment, the delivery provider 208 relays specifics of the delivery order, such as the delivery point 204, the product, the price, estimated time of arrival, and special requests to the remote data storage portion 220. The delivery provider 208 also relays the identifying signal 222 of the delivery vehicle 210 to the data storage portion 220. The private community 206 and/or the delivery provider 208 and/or the delivery requester 202 can receive information pertinent to the delivery order from the remote data storage portion 220.

In some embodiments, a resident lane 214 includes a reader 216 that communicates with the transponder to selectively enable passage of the delivery vehicle 210 through the resident lane 214. The reader 216 emits an interrogating signal 224 that is configured to access the identifying signal 222 from the transponder 212. The interrogating signal 224 communicates with the transponder 212 for verifying the identifying signal 222. The reader 216 attempts to match the identifying signal 222 from the remote data storage portion 220 with the identifying signal 222 of the delivery vehicle 210. In this manner the reader 216 can allow a single access to the delivery vehicle 210 through the resident lane 214 based on the identifying signal 222 of the transponder 212 of the delivery vehicle 210.

The reader 216 also communicates with the remote data storage portion 220 to access the delivery order information. The reader 216 and the remote data storage portion 220 work together to form a record of the delivery order and information about the enabled access through the resident lane 214.

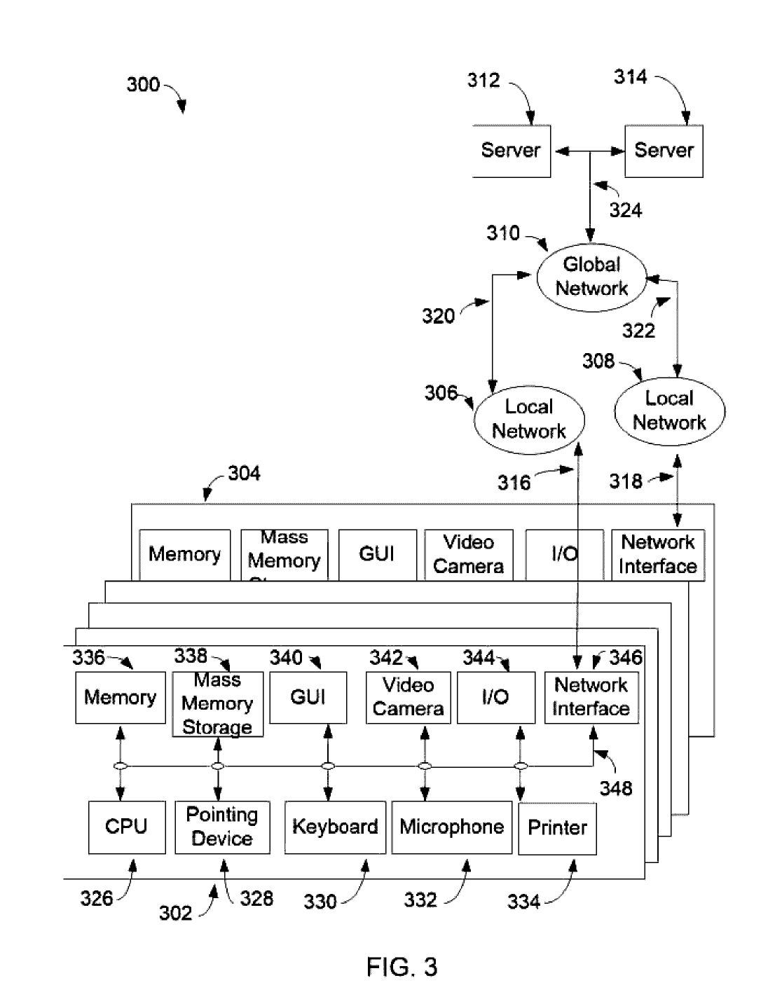

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the delivery method 100 and system 200 could be utilized for delivering injured or sick people to a hospital. Accordingly, the scope should be determined not by the embodiments illustrated, but by the appended claims and their legal equivalents.

What is claimed is:

1. A delivery method for allowing a delivery vehicle to deliver in resident lanes, the delivery method comprising:
requesting, by a delivery requester, a delivery order for delivery in a private community;
processing, by a delivery provider, the delivery order, the delivery order comprising at least a product and a delivery point;
selecting a delivery vehicle for performing the delivery order, the delivery vehicle comprising a transponder, the transponder comprising an identifying signal;
informing a remote data storage portion about the identifying signal of the delivery vehicle and the delivery order;
delivering the delivery order to a resident lane in the private community, the resident lane comprising a reader;
accessing the identifying signal and the delivery order, by the reader, from the remote data storage portion;
emitting an interrogating signal, by the reader, the interrogating signal configured to read the identifying signal on the transponder; and
allowing a single access to the delivery vehicle through the resident lane based on the identifying signal.

2. The delivery method of claim 1, wherein the method further comprises the reader informing the remote data storage portion when the single access through the resident lane is allowed.

3. The delivery method of claim 1, wherein the method further comprises the remote data storage portion informing the private community and/or the delivery requester and/or the delivery provider when the single access through the resident lane is allowed.

4. The delivery method of claim 1, wherein the resident lane further comprises an image capturing device, the image capturing device configured to capture an image of the delivery vehicle when the single access through the resident lane is allowed, wherein the private community receives the image and information related to the image.

5. The delivery method of claim 1, wherein the private community forms a delivery record from the information related to the delivery, the delivery record comprising at least a duration the delivery vehicle is in the private community.

6. The delivery method of claim 1, wherein the reader is operable to communicate with an active RFID windshield mounted transponder or a sticker RFID passive transponder.

7. The delivery method of claim 1, wherein the reader is operable to capture an image of a license plate on the delivery vehicle with optical character recognition technologies.

8. The delivery method of claim 1, wherein the method is operable in a gated residential community.

9. The delivery method of claim 1, wherein the reader and the transponder communicate with radio frequencies.

10. A delivery method for allowing a delivery vehicle to deliver in resident lanes, the delivery method comprising:
requesting, by a delivery requester, a delivery order for delivery in a private community;
processing, by a delivery provider, the delivery order, the delivery order comprising at least a product and a delivery point;
selecting a delivery vehicle for performing the delivery order, the delivery vehicle comprising a transponder, the transponder comprising an identifying signal;
informing a remote data storage portion about the identifying signal of the delivery vehicle and the delivery order;
delivering the delivery order to a resident lane in the private community, the resident lane comprising a reader;
accessing the identifying signal and the delivery order, by the reader, from the remote data storage portion;
emitting an interrogating signal, by the reader, the interrogating signal configured to read the identifying signal on the transponder;
allowing a single access to the delivery vehicle through the resident lane based on the identifying signal; and
informing, by the remote data storage portion, the private community, and/or the delivery requester and/or the delivery provider when the single access through the resident lane is allowed.

11. The delivery method of claim 10, wherein the resident lane further comprises an image capturing device, the image capturing device configured to capture an image of the delivery vehicle when the single access through the resident lane is allowed, wherein the private community receives the image and information related to the image.

12. The delivery method of claim 10, wherein the private community forms a delivery record from the information related to the delivery, the delivery record comprising at least a duration the delivery vehicle is in the private community.

13. The delivery method of claim 10, wherein the reader is operable to communicate with an active RFID windshield mounted transponder or a sticker RFID passive transponder.

14. The delivery method of claim 10, wherein the reader is operable to capture an image of a license plate on the delivery vehicle with optical character recognition technologies.

15. A delivery system for allowing a delivery vehicle to deliver a delivery order through resident lanes, the delivery system comprising:
a delivery requester configured to order a delivery order from a private community;
a delivery provider configured to process the delivery order, the delivery order comprising at least a product and a delivery point;
a delivery vehicle configured to deliver the delivery order, the delivery vehicle comprising a transponder, the transponder configured to emit an identifying signal;
a remote data storage portion configured to store the identifying signal and the delivery order, wherein the delivery provider relays the identifying signal and the delivery order to the remote data storage portion;
a resident lane configured to selectively enable passage of the delivery vehicle, wherein the resident lane is configured to expedite entry into the private community relative to a guest lane; and
a reader, the reader configured to access the delivery order from the remote data storage portion, the reader further configured to communicate with the transponder for verifying the identifying signal, wherein the reader is configured to allow a single access to the delivery vehicle through the resident lane based on the identifying signal from the remote data storage portion matching the identifying signal from the transponder, wherein the data storage portion is configured to inform the private community when the delivery vehicle passes the resident lane and a duration the delivery vehicle is in the private community.

16. The delivery system of claim 15, wherein the private community forms a delivery record from the information related to the delivery, the delivery record comprising at least a duration the delivery vehicle is in the private community.

17. The delivery system of claim 15, wherein the reader is operable to communicate with an active RFID windshield mounted transponder or a sticker RFID passive transponder.

18. The delivery system of claim 15, wherein the reader is operable to capture an image of a license plate on the delivery vehicle with optical character recognition technologies.

19. The delivery system of claim 15, wherein the system is operable in a gated residential community.

20. The delivery system of claim 15, wherein the reader and the transponder communicate with radio frequencies.
